(19) United States
(12) Patent Application Publication
(10) Pub. No.: US 2013/0086037 A1
(43) Pub. Date: Apr. 4, 2013

(54) ENCAPSULATED, MODEL-CENTRIC AGGREGATION OF DATA FROM DIFFERENTIATED DATA SOURCES

(71) Applicants: Thomas Hejlsberg, Horsholm (DK); Christine A. Avanessians, Kobenhavn (DK); Torben Wind Meyhoff, Frederikssund (DK); Bardur Knudsen, Kongens Lyngby (DK); Esben Nyhuus Kristoffersen, Dyssegaard (DK); Yury Belenky, Snekkersten (DK); Lars Hammer, Frederiksberg (DK)

(72) Inventors: Thomas Hejlsberg, Horsholm (DK); Christine A. Avanessians, Kobenhavn (DK); Torben Wind Meyhoff, Frederikssund (DK); Bardur Knudsen, Kongens Lyngby (DK); Esben Nyhuus Kristoffersen, Dyssegaard (DK); Yury Belenky, Snekkersten (DK); Lars Hammer, Frederiksberg (DK)

(73) Assignee: Microsoft Corporation, Redmond, WA (US)

(21) Appl. No.: 13/411,649

(22) Filed: Mar. 5, 2012

Related U.S. Application Data
(60) Provisional application No. 61/543,274, filed on Oct. 4, 2011.

(51) Int. Cl. G06F 17/30

(52) U.S. Cl. 707/713; 707/E17.017

(57) ABSTRACT

A reusable ERP data retrieval object, in particular, a wide application query object provides a systematic and standardized approach to data retrieval. In one embodiment, the wide application query object is an encapsulated query object in that multiple queries are aggregated into one master query object (i.e., the wide application query object) that can, but does not necessarily have to, span multiple disparate data sources. In another embodiment, data retrieved in accordance with the wide application query logic is manipulated by code in any of a variety of different ways using a trigger model and specialized constructs. In still another embodiment, public parameters are utilized to trigger functions that impact the substance and layout of the query output.

### BACKGROUND

There is significant variation in terms of the particular functions included in enterprise resource planning (ERP) products currently on the market. However, most applications in this category support some degree of integration across different segments of a business organization. For example, a given ERP application may include support for any or all of finance/accounting, manufacturing, sales, service, customer relationship management, and supply chain management operations, and this is even an incomplete list of potentially supported operations. In order to effectively support such broad functionality, a good ERP system will be robust enough to efficiently and effectively account for differences across sources of data associated with the various supported business operations.

Further, while different ERP systems will be implemented differently in terms of the particular hardware and network configuration, most ERP systems will employ a centralized database as a repository for information. Data is commonly retrieved by way of table access based on instructions embedded directly in code. The data retrieval processes often will vary depending at least upon usage and context (e.g., depending upon whether the data is for supporting a user interface, reporting, exposure through a web-service, etc.). Circumstances such as these make it difficult to effectively manage data at least because it is difficult to track and conceptualize where data access occurs, from what data sources and for what purpose.

The discussion above is merely provided for general background information and is not intended to be used as an aid in determining the scope of the claimed subject matter.

### SUMMARY

Embodiments pertain to a reusable ERP data retrieval object, in particular, a wide application query object providing a systematic and standardized approach to data retrieval. In one embodiment, the wide application query object is an encapsulated query object in that multiple queries are aggregated into one master query object (i.e., the wide application query object) that can, but does not necessarily have to, span multiple disparate data sources. In another embodiment, data retrieved in accordance with the wide application query logic is manipulated by code in any of a variety of different ways using a trigger model and specialized constructs. In still another embodiment, public parameters are utilized to trigger functions that impact the substance and layout of the query output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic diagram of an ERP data management system.

FIG. 2 is a schematic illustration of an encapsulated query system.

FIG. 3 is a schematic block diagram demonstrating an example flow of execution in relation to an embodiment of the encapsulated query system.

FIG. 4 is a state diagram demonstrating state transitions and operations of an instance of a wide application query object.

FIG. 5 is a programmatic flow diagram demonstrating an exemplary programming model for supporting the operation and configuration of an instance of the wide application query object.

FIG. 6 is an example of a tablet computer presenting a screen shot demonstrating user-oriented controls utilized to set configuration options in association with an instance of the encapsulated query object.

FIG. 7 is another example of a tablet computer presenting a screen shot demonstrating user-oriented controls utilized to set configuration options in association with an instance of the encapsulated query object.

FIG. 8 is an example of a tablet computer presenting a screen shot demonstrating user-oriented controls utilized to set query properties in association with an instance of the encapsulated query object.

FIG. 9 is another example of a tablet computer presenting a screen shot demonstrating user-oriented controls utilized to set query properties in association with an instance of the encapsulated query object.

FIG. 10 is another example of a tablet computer presenting a screen shot demonstrating user-oriented controls utilized to set query properties in association with an instance of the encapsulated query object.

FIG. 11 is a tablet computer presenting a screen shot simply demonstrating that a user-oriented control is illustratively provided to enable a user to selectively set the timing of wide query object functions in terms of how and when data is compiled.

FIG. 12 is a schematic block diagram of an embodiment of a computing device with which embodiments may be implemented.

FIG. 13 is a schematic block diagram of an embodiment of another computing device with which embodiments may be implemented.

FIG. 14 is a schematic block diagram of an embodiment of another computing device with which embodiments may be implemented.

FIG. 15 is a schematic block diagram of an embodiment of another computing device with which embodiments may be implemented.

FIG. 16 is a schematic block diagram of an embodiment of another computing environment within which embodiments may be implemented.

### DETAILED DESCRIPTION

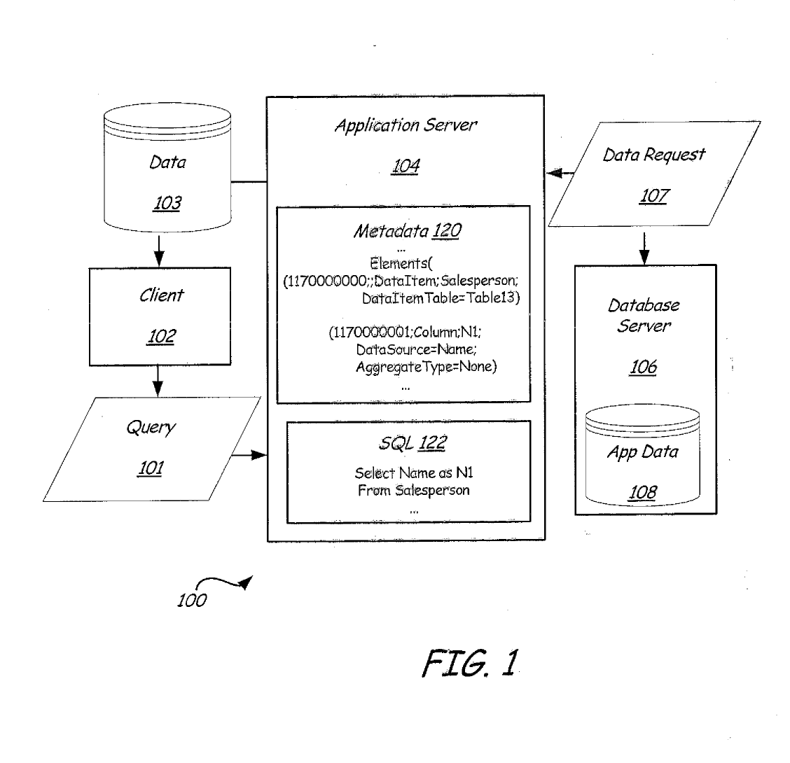

FIG. 1 is a schematic diagram of an embodiment of an ERP data management system 100. System 100 demonstrates query management in the context of a single data source 106. An application client 102 provides an application query 101 to an application server 104. From the query, the application server identifies corresponding metadata 120 and/or data request information 122. Within the Figure, the data request information 122 is identified as SQL information. However, it is to be understood that it is not critical which particular database type or database management technology is utilized. The concept of a SQL database and inference of SQL database management are provided simply for the purpose of giving specific examples.

The application server 104 outputs a data request 107 that is illustratively based at least in part on metadata 120 and/or data request information 122. The request 107 is provided to a database server 106 upon which application data 108 is stored. The request is illustratively represents a request for at least a portion of the application data 108. The database server processes the request and returns corresponding data 103 back to the application server 104. The corresponding data is ultimately returned to the client 102 by way of the application server 104 as a response to the query 101. The application server 104 may or may not further process (e.g., add metadata, change format, etc.) the data 103 before it is provided to client 102 as the response to the query 101. In one embodiment, the further processing applied by the application server includes adjustments to the actual data such as but not limited to modifications to column values, adding of a new column, etc. Within FIG. 1, providing the query response from server 104 back to the client 102 is shown as the transfer of data 103.

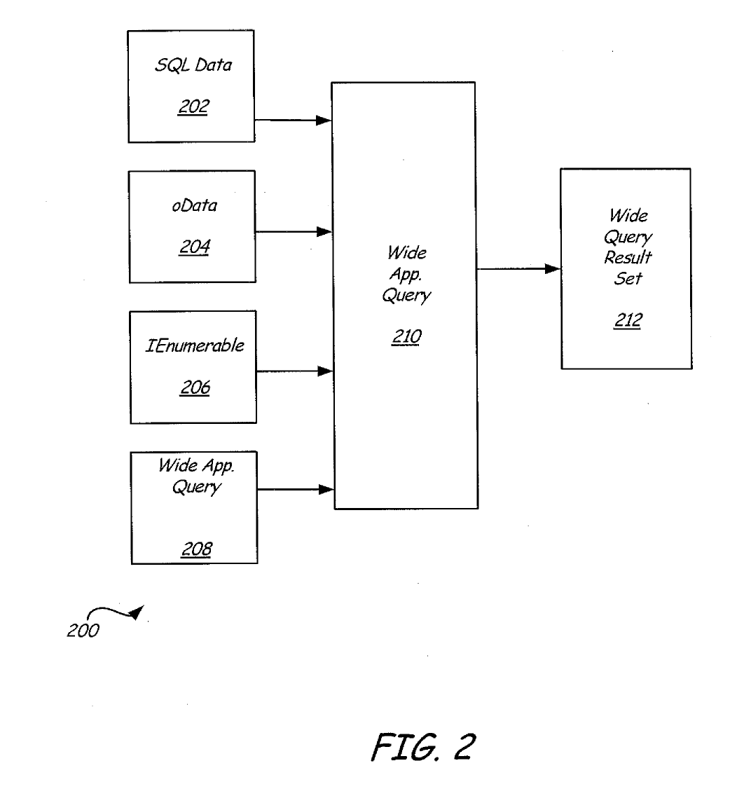

FIG. 2 is a schematic illustration of an encapsulated query system 200 that is illustratively applied in the context of an ERP data management environment the same or at least similar to that shown and described in relation to FIG. 1. Within system 200, data is consumed from multiple data sources 202, 204, 206 and 208 in accordance with logic encapsulated within a single ERP data retrieval object, namely, a wide application query object 210 (which also is referred to herein as “an encapsulated query object”). The wide application query object 210 illustratively provides a relatively predictable way of retrieving data generally regardless of how the retrieved data is to be consumed. The query object 210 effectively aggregates multiple encapsulated queries into one master query that can, but does not necessarily have to, span multiple data sources. In one embodiment, the query object 210 includes code that causes retrieved data to be selectively manipulated using a trigger model and specialized constructs such as, but not necessarily limited to skip, yield and break constructs. In still another embodiment, the query object 210 includes code that causes public parameters to be utilized to selectively trigger a filtering of the retrieved data. The application server illustratively applies the functions of the query object when generating the response to the submitted wide application query object.

In essence, the wide application query object 210 operates as an abstraction and programming model supporting an encapsulation of data acquisition processes across the data sources 202, 204, 206 and 208. In FIG. 2, the data sources are identified as including SQL server table data, an oData dataset from “the cloud,” an IEnumerable data set, and even data from another wide application query. Certainly query object 210 may be configured for data retrieval from other and different combinations of data sources. The sources provided herein are exemplary only.

As has been alluded to, in one embodiment, the query object 210 supports the ability to selectively incorporate hooks into the flow of execution of the encapsulated data acquisition processes so as to manipulate a resulting data set 212. Also supported is the ability to selectively incorporate specialized constructs (such as but not necessarily limited to yield, skip, and break keyword constructs) in order to create, interrupt, and/or ignore data when producing the resulting data set 212. Thus, a conveniently flexible customization of the output data 212 is supported.

At least some if not all of the programmatic logic that supports the described data retrieval processes is illustratively contained in the wide application query object 210 itself. In one embodiment, though not necessarily by limitation, the data set 212 that is the result of the processing of the query object 210 is a wide flat data set generally regardless of the types of specific encapsulated queries incorporated into the query object 210. The wide application object query 210 and the wide query result set 212 are illustratively formatted so as to be reusable or otherwise utilized by multiple consumers. As is suggested by the inclusion of wide application query object 208 in FIG. 2 as a data source feeding into the wide application query 210, multiple wide application queries can even be configured to operate relative to one another. Thus, one wide application query can be a source of data to another wide application query.

It is worth mentioning that the approaches described herein for selectively controlling the nature of output data set 212 during the processing of the encapsulated queries of query object 210 enable creator and consumer perspectives to be considered separately. For example, one option is for a function of the query object 210 to be designated as mutable or immutable. For example, a filtering function may be applied within the programmatic logic of the query object 210 in either a mutable or immutable manner. The filtering function might be set as immutable if, for example, the developer desired the function to be mandatory. In contrast, a filtering function might be set as mutable if there is a desire to allow an end user to choose to mute or not mute the function depending upon user preference. Further, muting or not muting determinations can, in one embodiment, be made dependent upon the outcome of an automated variable determination e.g., dependent upon the value of a designated parameter that may be internal or external relative to the wide application query object 210). In fact, the logic of a wide application query object is illustratively configurable such that any function can be selectively tied to or otherwise made dependent upon an internal or external parameter, flag, event or variable.

In accordance with another embodiment, another option for utilizing the programmatic logic of the wide application query object 210 to manipulate the data output 212 is the configuration of the query object to include a memory-only column. In one example of this, the wide application query object is configured to create a “column” or other unit of data where it did not otherwise already exist in the body of data from which data is being retrieved. For example, a computer-implemented instruction can be included in the query object to add tax to each entry in a listing of prices being retrieved, and then to include price-plus-tax amounts in a particular portion of the resulting data set.

In accordance with still another embodiment, application functionality is triggered based upon a logical programmatic inference of a relationship as reflected in the underlying configuration or constructs of a field identified relative to a wide application query object 210. For example, an inference can be made based upon particular selections made by a user (or possibly even a developer) relative to the configuration of an instance of the wide application query object. Such an inference can be utilized programmatically as a basis for initiating an automatic generation of, for example but not by limitation, a short cut within, or an automatic narrowing down of, a selection process. In one embodiment, such a query definition inference is utilized to programmatically trigger an automatically generated definition of a portion of a “Group by” configuration. In another embodiment, an abstraction from the underlying data model is utilized to programmatically trigger an automatic population of a DataItemLinkType. Still further, in one embodiment, such an inference is utilized to programmatically trigger an automatic expansion or selection within the context of one or more ERP application and/or wide application query object fields. Still other embodiments pertain to a programming model (illustratively in a domain specific language, for example, C/AL) that encapsulates and combines reader, row, and builder functionality into one object construct (i.e., the wide application query object 210) that behaves in a similar manner for further encapsulation and simplicity. These are just examples, not by limitation, of possible embodiments.

One skilled in the an will appreciate that some embodiments therefore pertain to a tabular approach enabling a designer or other user (e.g., a developer) to selectively configure a wide application query object and thereby statically define the definition of a resulting data set. The approach enables the designer to select fields from multiple different data sources, even including data associated with another wide application query object. Further, the approach enables aggregation on data and supports filtering on fields. Still further, the approach supports a trigger model encapsulated within the query definition so as to enable dynamic manipulation of the resulting data set before exposure to the consumer. In accordance with some embodiments, but not by limitation, supported options for the timing of manipulations include:

OnBeforeOpen—Before the underlying data retrieval has been executed

OnAfterOpen—Right after the underlying data retrieval has been executed before rows are read

OnAfterFetchRow—Processing right after reading each row

OnEndOfResultset—After entire dataset has been read

OnClose—Once the data retrieval is complete and nothing more should be done within this encapsulated scope

Thus, with the appropriate hooks into the flow of execution, it is possible to selectively control within the wide application query object the outcome of data retrieval from selected data sources. The addition of support for data retrieval processes relative to functions consistent with Yield, Break, and Skip keywords also enables, for example, insertion of a code-generated row, ignoring of the remaining rows when a condition is met, and/or ignoring of a single row, respectively. As has been described, it is also possible to add columns to the each of the rows of the resulting data set that persist only in memory. Thus, the view provided to the rest of the ERP application can be quite different than what is solely in the SQL database or other data source in which business data is persisted.

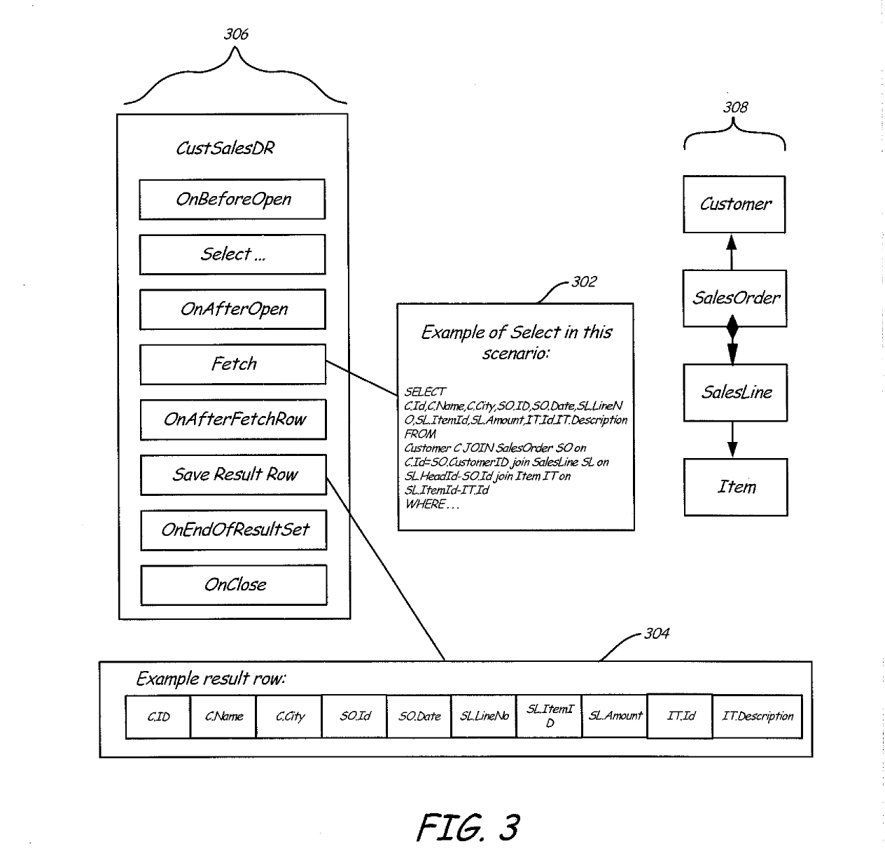

FIG. 3 is a schematic block diagram demonstrating an example flow of execution in relation to a more specific example of a trigger model encapsulated in a wide area query object, embodiments of which have been described. Area 306 shows an exemplary set of encapsulated process instructions. Accordingly, area 306 shows an exemplary flow of execution in relation to the query object. Box 302 shows an example of one exemplary select operation included within the logic of the query object. Area 308 shows an example of an applicable data organization scheme. Finally, box 304 shows a wide flat row generated as part of the resulting data set in accordance with a portion of the data processing logic included in the query object.

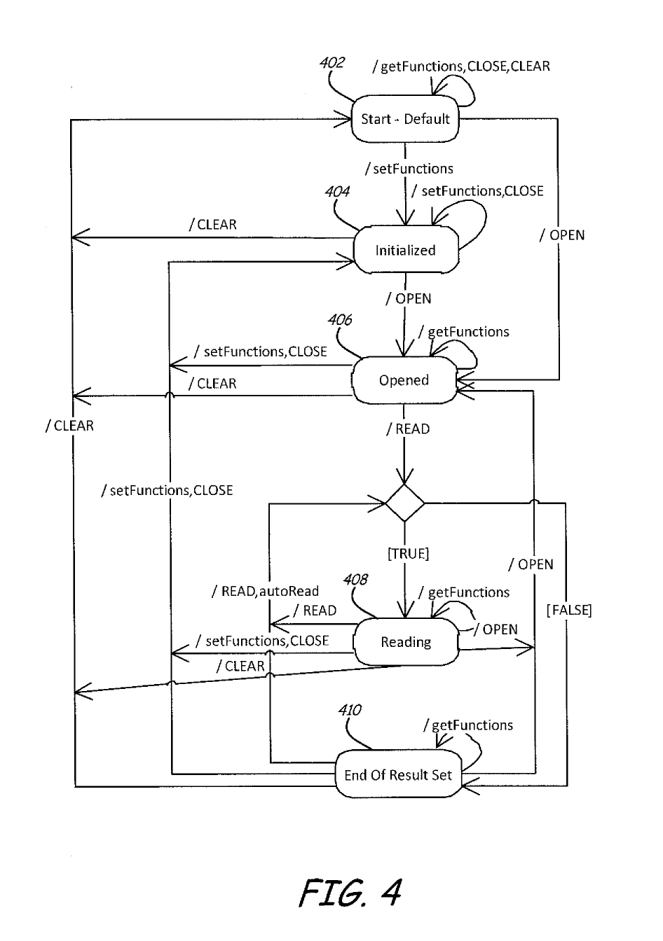

FIG. 4 is an exemplary state diagram demonstrating state transitions and related operations in the context of an exemplary wide application query object, embodiments of which have been described. As is shown in relation to block 402, the process begins in a starting or default state. There is a transition to an opened state 406, which may be by way of an initialization process and corresponding state, which is signified by block 404. As is shown in relation to the initialization and opened states (404 and 406, respectively), functions are obtained and set as appropriate. The next state is reading 408 (unless there is nothing to read, in which case the system returns the object to its starting default state 402 by way of block 410 and a corresponding ending state). Reading illustratively continues until the end of the result set is reached, as is reflected by the connection to block 410 and its associated ending state. The query object is thus systematically transitioned so as to read data in accordance with any relevant encapsulated object functions, thereby affecting creation of the output data set.

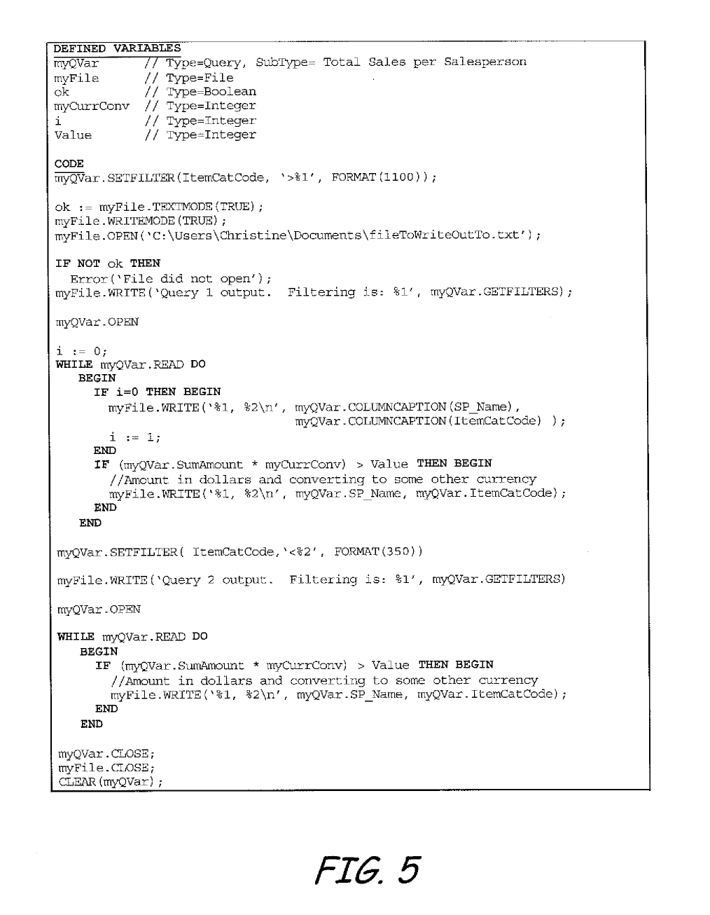

FIG. 5 is a programmatic flow diagram demonstrating an exemplary programming model (e.g., OPEN, READ, CLOSE) for supporting the operation and configuration of an instance of a wide application query object, embodiments of which are described herein. The example shown in FIG. 5 includes a currency conversion function applied from within the logic of the query object. Under the heading “DEFINED VARIABLES,” a plurality of types are defined for six different variables. Then, a collection of associated programming code for the query object is provided under the “CODE” heading. In addition to demonstrating the programming model, the code shows an example of how additional dynamic filters may be set on the wide application query object. Those skilled in the art will appreciate that this is but one of an essentially unlimited number of combinations of filters and functions.

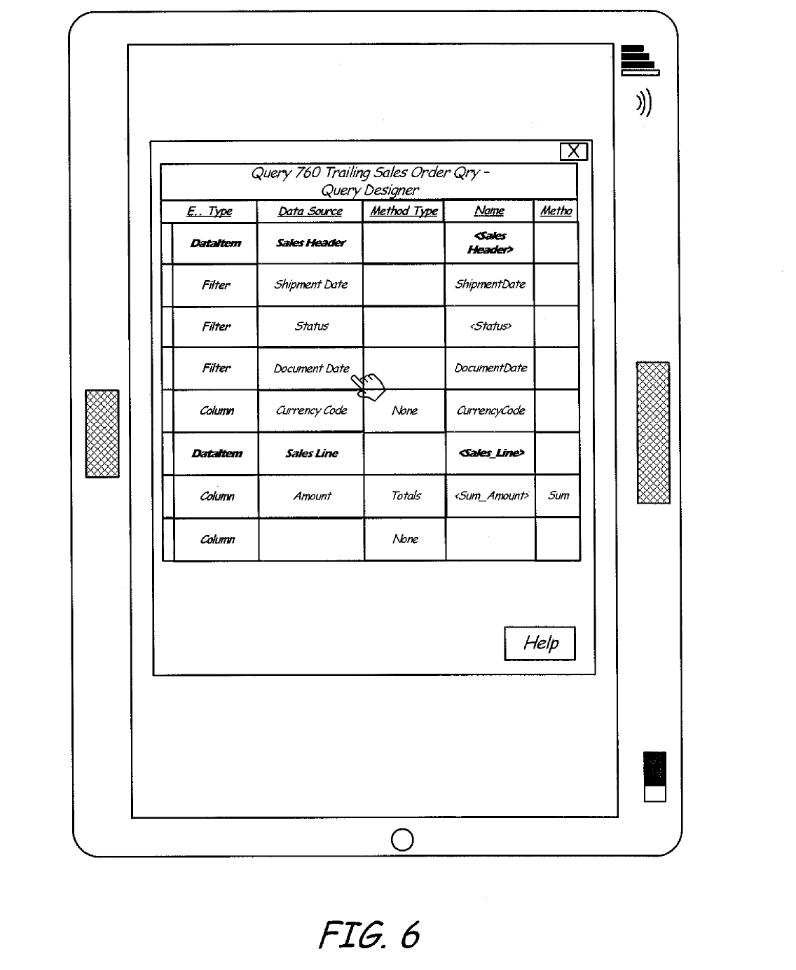

FIG. 6 is an example of a tablet computer presenting a “main query designer” screen shot demonstrating controls utilized by a user (e.g., a developer, etc.) to set configuration options and thereby select the nature of the output produced when the corresponding wide application query object is executed. The first part of the query designer (i.e., the first column) enables the user to choose a type for components of the query. In FIG. 6, for example, two different data items are shown in the first column, each with associated filter or column sub-components. The second part of the query designer (i.e., the second column) enables the user to choose a data source for each data item or sub-component identified in the first part. Finally, support for the selection of a method type, a name, and a method operation are also provided in the query designer interface.

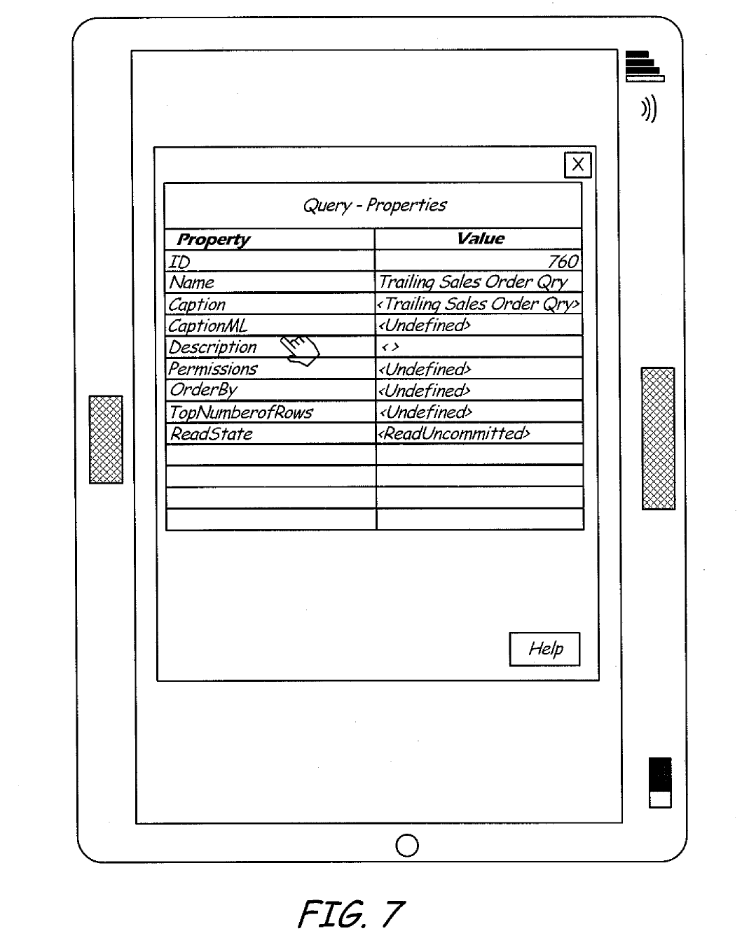

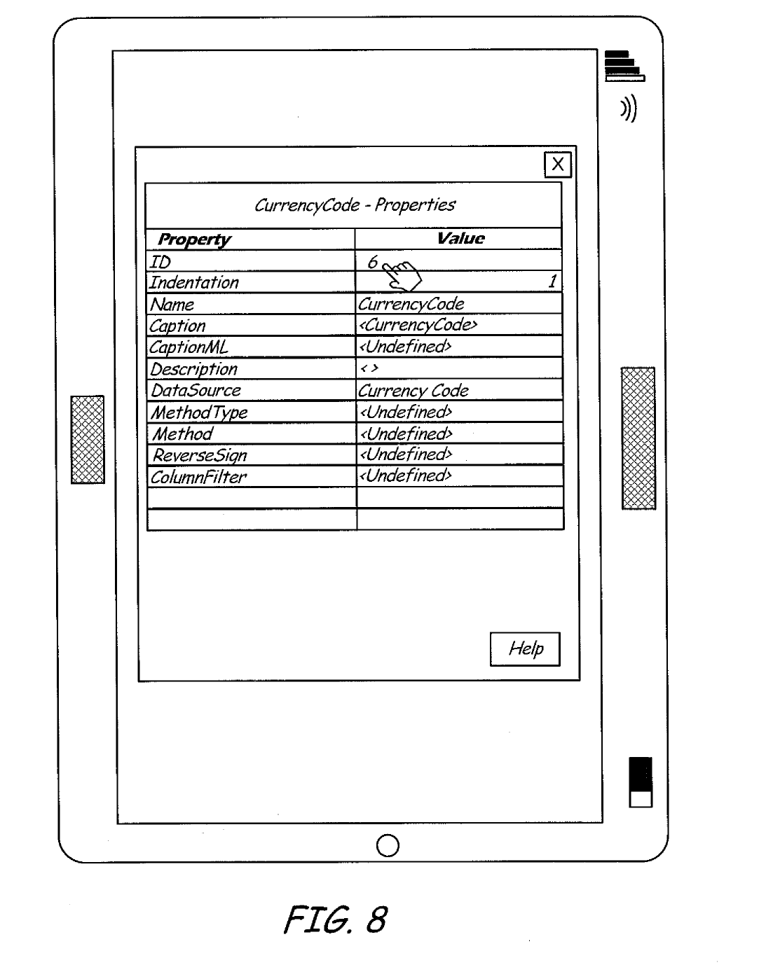

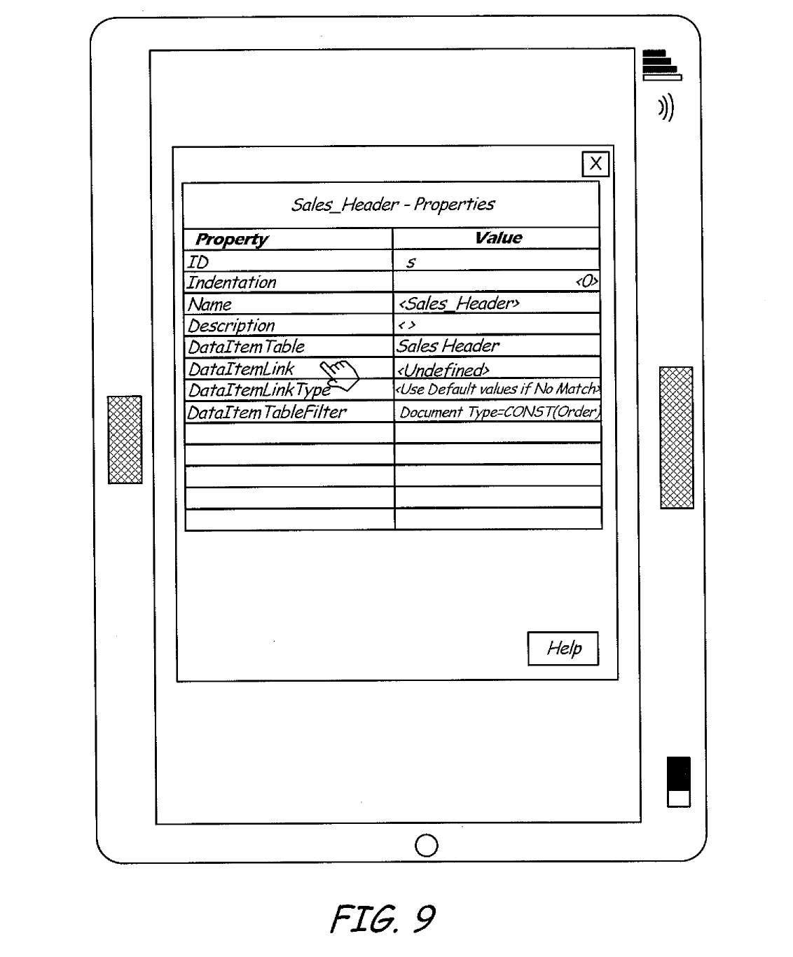

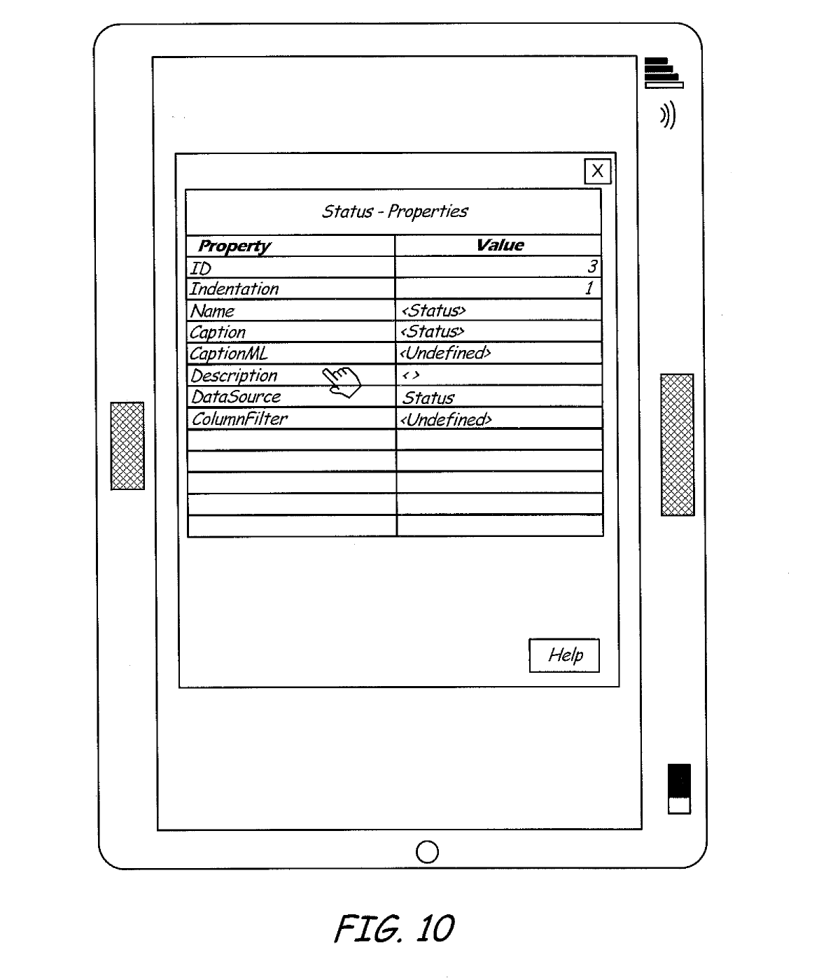

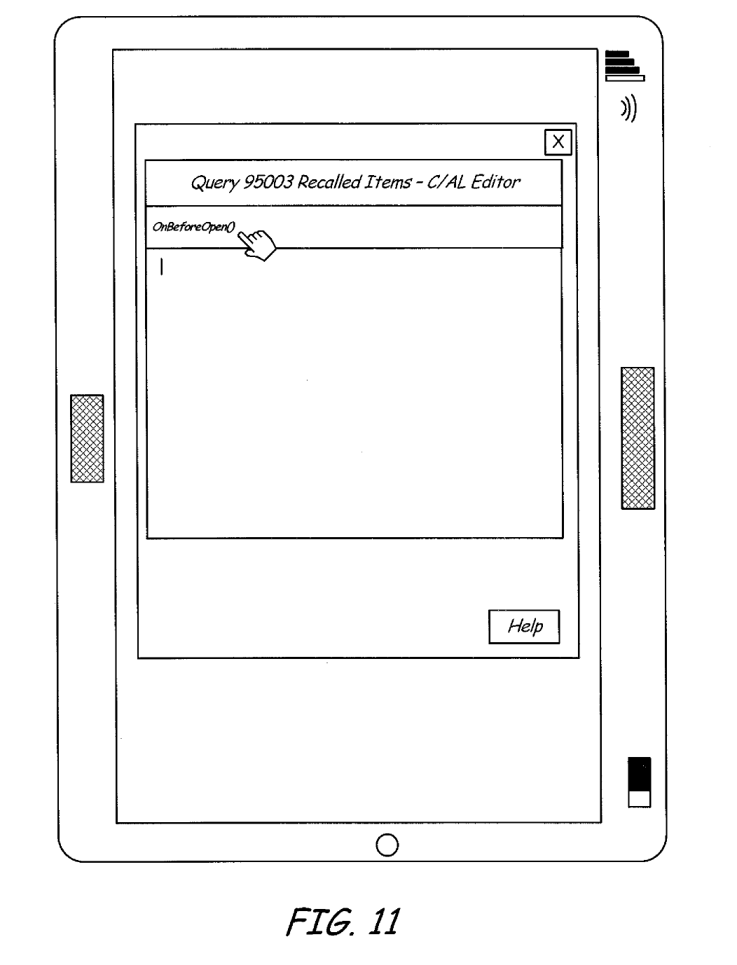

FIG. 7 is an example of a tablet computer presenting an “entire query object properties” screen shot demonstrating controls utilized by a user (e.g., a developer, etc.) to set query component properties in association with an instance of a wide application query as has been described. FIG. 8 is an example of a tablet computer presenting an “column properties” screen shot demonstrating controls utilized by a user (e.g., a developer, etc.) to set query component properties in association with an instance of a wide application query as has been described. FIG. 9 is an example of a tablet computer presenting a “data item properties” screen shot demonstrating controls utilized by a user (e.g., a developer, etc.) to set query component properties in association with an instance of a wide application query as has been described. FIG. 10 is an example of a tablet computer presenting a “filter column properties” screen shot demonstrating controls utilized by a user (e.g., a developer, etc.) to set query component properties in association with an instance of a wide application query as has been described. These Figures show how the user can access mechanisms for configuring functions and filters in order to customize the query output as desired. Finally, FIG. 11 shows one example of a tablet computer presenting a timing mechanism that illustratively may be tied to a function for adjusting when the function (e.g., a filter is applied).

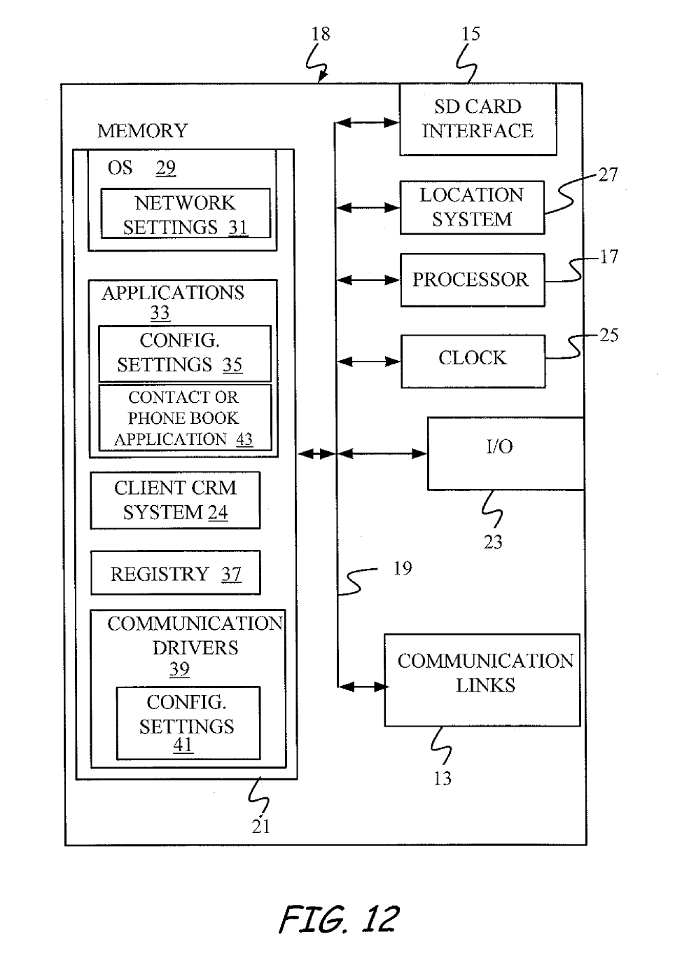

FIGS. 12-15 show a number of different embodiments for computing devices upon which embodiments may be implemented. While these embodiments will be described in FIGS. 12-15, it should be noted that these are not exclusive, but are provided as illustrative and exemplary descriptions of embodiments of devices.

While systems (e.g., software applications) that implement encapsulated queries consistent with embodiments described herein can primarily reside on a client device such as those specifically shown herein, such systems could just as easily be embodied elsewhere, such as in a cloud computing environment. Cloud computing provides computation, software, data access, and storage services that generally do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the functions described herein can be provided from a service provider at a remote location using a cloud computing architecture. Alternatively, they can be provided front a conventional server, or they can be installed on a client device directly.

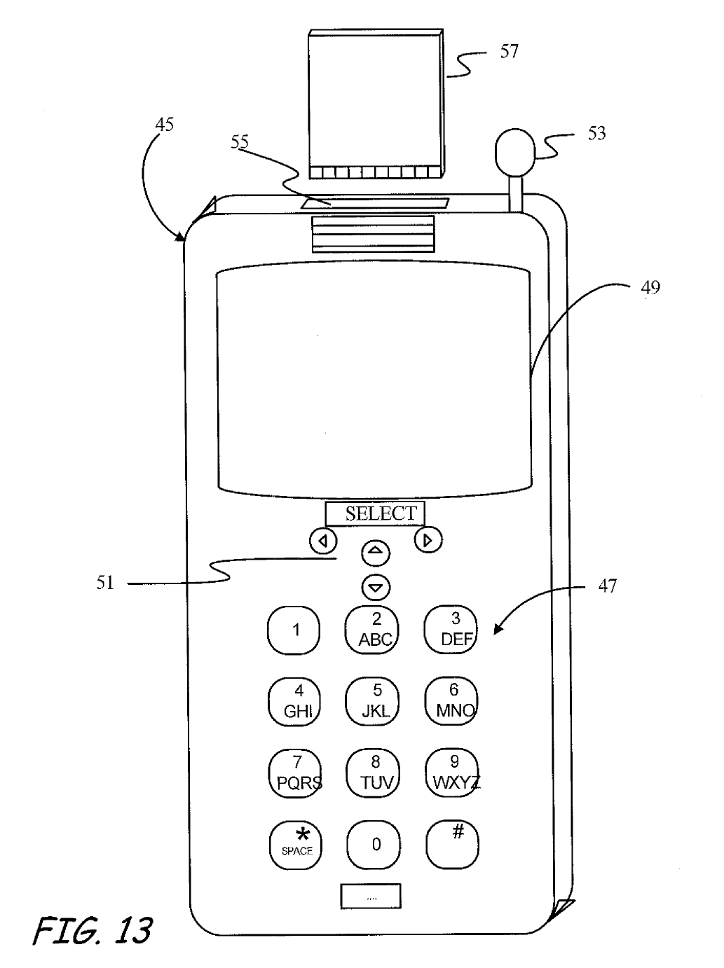

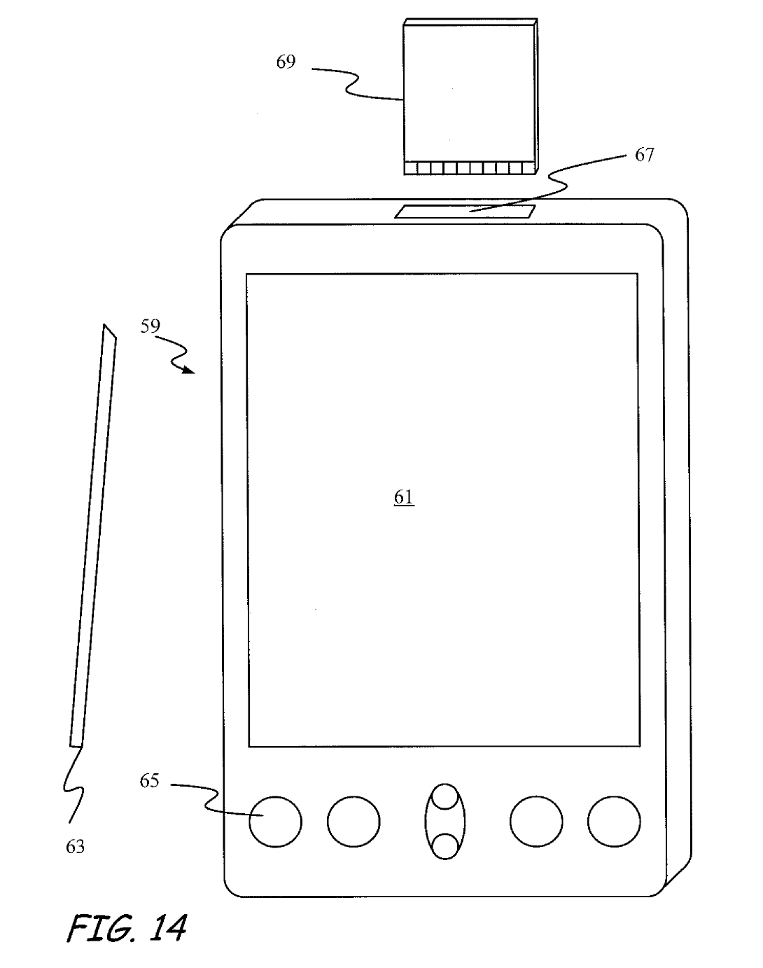

In any case, FIG. 12 is a simplified block diagram of one illustrative embodiment of a handheld or mobile computing device that can be used as a client device, upon which systems that implement embodiments may be deployed. FIGS. 13 and 14 are examples of handheld or mobile devices.

FIG. 12 provides a general block diagram of the components of a client device. In the device, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations, I/O components 23 for various embodiments of the device can include input components such as buttons, touch sensors, touch screens, proximity sensors, microphones, tilt sensors, and gravity switches and output components such as display device 26, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 18. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, registry 37, communication drivers 39, and communication configuration settings 41. Memory 21 can include all types of tangible volatile and non-volatile computer-readable memory devices. Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 18 or applications that are installed during use. In one embodiment, applications 33 can be part of operating system 29, or hosted external to device 18, as well.

FIGS. 13 and 14 provide examples of devices 18 that can be used, although others can be used as well. In FIG. 13, a smart phone or mobile phone 45 is provided as the device 18. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals, in some embodiments, phone 45 also includes a Secure Digital (SD) card slot 55 that accepts a SD card 57.

The mobile device of FIG. 14 is a personal digital assistant (PDA) 59 or a multimedia player or a slate or tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 18 are possible. Examples include tablet or slate computing devices, music or video players, and other handheld computing devices.

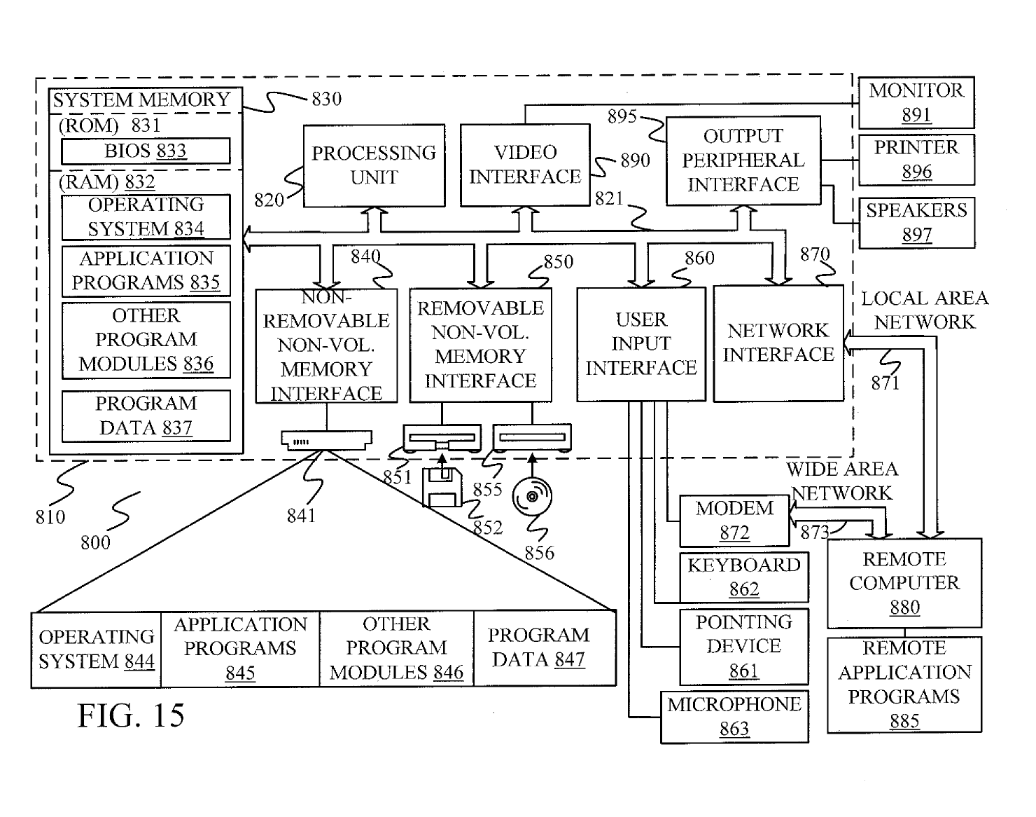

FIG. 15 is one embodiment of another computing environment. With reference to FIG. 15, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media cart be any available media that can be accessed by computer 810 and includes both volatile and nonvolatile media, removable and non-removable media. By way of example, and not limitation, computer readable media may comprise computer storage media and communication media. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates operating system 834, application programs 835, other program modules 836, and program data 837.

The computer 810 may also include other removable/non-removable volatile/nonvolatile computer storage media. By way of example only, FIG. 7 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. They can also include search components 802 and 804.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on remote computer 880. It will be appreciated that the network connections shown are exemplary and other means of establishing a communications link between the computers may be used.

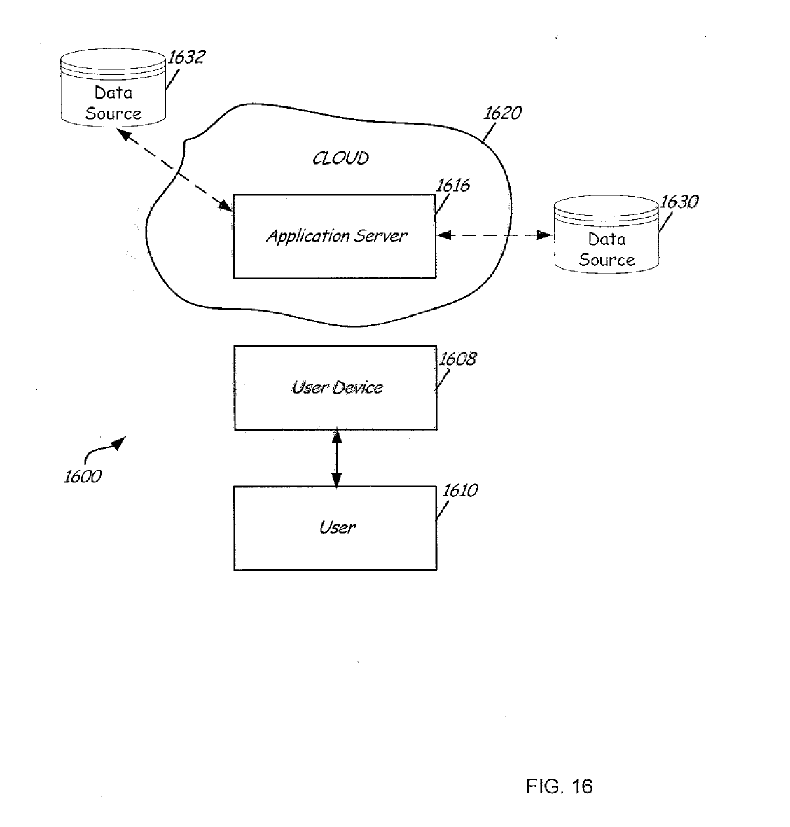

FIG. 16 is a block diagram of an ERP data management environment 1600 that is the same or similar to system 100, shown in FIG. 1, except that this time an application server 1616 is disposed for operation within a cloud computing architecture. Cloud computing provides computation, software, data access, and storage services that do not require end-user knowledge of the physical location or configuration of the system that delivers the services. In various embodiments, cloud computing delivers the services over a wide area network, such as the Internet, using appropriate protocols. For instance, cloud computing providers deliver applications over a wide area network and they can be accessed through a web browser of any other computing component. Software or components of system 100 as well as the corresponding data cart be stored on servers at remote locations. Within FIG. 16, multiple data sources 1630 and 1632 are shown in order to infer that the multiple source embodiments of wide application query processing, such as was described at least in relation to FIG. 2, are also applicable to system 1600. Of course, the multiple data sources need not be maintained in the same location. The computing resources in a cloud computing environment can be consolidated at a remote data center location or they can be dispersed. Cloud computing infrastructure can deliver services through shared data centers, even though they appear as a single point of access for the user (e.g., user 1610 using device 1608 to access the cloud hosted application server 1616. Thus, the components and functions described herein can be provided from a service provider at a remote location using a cloud computing architecture. Alternatively, they can be provided from a conventional server, or they can be installed on client devices directly, or in other ways.

This description is intended to include both public cloud computing and private cloud computing. Cloud computing (both public and private) provides substantially seamless pooling of resources, as well as a reduced need to manage and configure underlying hardware infrastructure. A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization may still maintain the hardware to some extent, such as installations, repairs, etc.

Accordingly, system 1600 is illustratively also an encapsulated query system that is applied in the context of an ERP data management environment the same or at least similar to that shown and described in relation to FIG. 1. Within system 1600, data is consumed from multiple data sources 1630 and 1632 in accordance with logic encapsulated within a single ERP data retrieval object, namely, a wide application query object, as has been described herein. The query is illustratively submitted by user 1610 using a user device 1608, examples of applicable devices also being described herein. The application server 1616 applies the functions of the query object when generating the response to the submitted wide application query object.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for aggregating data from a plurality of differentiated data sources, comprising:
receiving a wide application query object that includes a plurality of encapsulated individual queries; and
processing the wide application query object so as to produce a resulting data set that combines data retrieved as a result of processing the plurality of encapsulated individual queries and thereby obtaining data from the plurality of differentiated data sources.

2. The method of claim 1, wherein the wide application query object comprises a trigger model component that provides a hook into said processing of the wide application query object, the hook including an instruction related to how the data retrieved as a result of the processing of the plurality of individual queries is to be combined within the resulting data set.

3. The method of claim 1, wherein the wide application query object comprises a keyword trigger that is an instruction related to how the data retrieved as a result of the processing of the plurality of individual queries is to be combined within the resulting data set.

4. The method of claim 1, wherein the resulting data set is a wide flat data set.

5. The method of claim 1, wherein the resulting data set includes data from fields from all of the plurality of differentiated data sources, the fields being specifically identified in the wide application query object.

6. The method of claim 1, wherein the wide application query object comprises a loops functionality with associated joined rows.

7. The method of claim 1, wherein at least one of the plurality of differentiated data sources is another, different wide application query object.

8. The method of claim 1, wherein the wide application query object includes a function designated as being mutable.

9. The method of claim 1, wherein the wide application query object includes an instruction for altering a column layout when generating the resulting data set.

10. A computer implemented method for creating a wide application query object, the method comprising:
providing a query builder user interface with identification of a plurality of differentiated data sources:
providing the user interface with instructions for configuring a trigger model instantiation that will affect how, when the wide application query object is executed, data from the plurality of differentiated data sources will be combined into a single resulting data set.

11. The method of claim 10, further comprising providing the user interface with instructions as to how the data from the plurality of differentiated data sources is to be joined in the single resulting data set.

12. The method of claim 10, wherein the instructions for configuring the trigger model instantiation comprise a selection of a trigger based hook into said execution of the wide application query object.

13. The method of claim 10, wherein the identification of the plurality of differentiated data sources comprises an identification of a second, different wide application query object.

14. The method of claim 10, further comprising providing the user interface with instructions for adding a collection of data to the single resulting data set that is derived from one of the plurality of differentiated data sources but not specifically included in one of the plurality of differentiated data sources.

15. The method of claim 10, further comprising providing the user interface with instructions for excluding from the single resulting data set at least a portion of the data in one of the plurality of differentiated data sources.

16. A computer implemented system for creating a wide a cation query object, the method comprising:
a query builder user interface component that receives an identification of a plurality of differentiated data sources; and
a query configuration component that receives instructions that configure a trigger model instantiation that affects how, when the wide application query object is executed, data from the plurality of differentiated data sources is combined into a single resulting data set.

17. The system of claim 16, wherein the instructions that configure the trigger model include a key word instruction that signals an instruction to exclude a portion of data from one of the plurality of differentiated data sources from the single resulting data set.

18. The system of claim 16, wherein the identification of the plurality of differentiated data sources includes identification of another, different wide application query object.

19. The system of claim 16, wherein the instructions that configure the trigger model to include a filter instruction.

20. The system of claim 16, wherein the filter instruction is identified in the trigger model as being mutable.
